(19) United States
(12) Patent Application Publication
(10) Pub. No.: US 2014/0319957 A1
(43) Pub. Date: Oct. 30, 2014

(54) LOW TORQUE RIPPLE ELECTRIC DRIVE SYSTEM FOR BAS APPLICATION

(71) Applicant: GM GLOBAL TECHNOLOGY OPERATIONS LLC, Detroit, MI (US)

(72) Inventors: Lei Hao, Troy, MI (US); Chandra S. Namuduri, Troy, MI (US); Thomas Wolfgang Nehl, Shelby Township, MI (US); John C. Morgante, Sterling Heights, MI (US)

(73) Assignee: GM GLOBAL TECHNOLOGY OPERATIONS LLC, DETROIT, MI (US)

(21) Appl. No.: 13/871,756

(22) Filed: Apr. 26, 2013

(51) Int. Cl. H02K 17/16

(52) U.S. Cl. CPC H02K 17/165
USPC 310/211

(57) ABSTRACT

A BAS machine that includes a specific combination of the number of stator slots to the number of rotor bars to reduce torque ripple without the need for skewing the rotor bars. Particularly, the ratio of the number of stator slots to the number of rotor bars is selected to prevent first and second order harmonics between the stator slots and the rotor bars, where the ratio includes 36/26, 54/44, 72/56, 72/58 or 72/62 for a six pole machine, 48/36, 72/52, 72/58 or 84/86 for an eight pole machine, and 60/44 or 60/46 for a ten pole machine.

### BACKGROUND OF THE INVENTION

1. Field of the Invention

This invention relates generally to a belted-alternator-starter (BAS) system for a vehicle and, more particularly, to a BAS system for a vehicle that provides low torque ripple without the need for skewed rotor bars.

2. Discussion of the Related Art

Vehicles employ alternators that are driven by a belt coupled to the vehicle engine to provide electrical power. The alternator includes a rectifier circuit to convert AC current to DC current to charge the vehicle battery. The field current of the alternator is regulated to provide the proper battery charge. Particularly, claw-pole, wound rotor AC synchronous machines are used in combination with a rectifier circuit and a field current regulator in vehicles as a belt-driven generator. Permanent magnets have been employed in the claw-pole machine to increase the power output and efficiency of the alternator for a given alternator size.

Certain state of the art vehicle designs have investigated using the alternator as a starter motor to start the engine so that the vehicle engine can be turned off when the vehicle is stopped, such as at a stop light, to conserve fuel. These devices are typically known as belted-alternator-starters (BAS). The torque required to start the engine when it is warm is much less than the torque required when the engine is cold. Therefore, a starting device is required to provide the necessary high torque for cold starts. In conventional power-trains, the starter motor provides this torque and starts the engine relatively slowly. Because the alternator is directly connected to the engine by the belt, and thus has a smaller pulley ratio compared to the gear ratio of the starter motor, it has to be designed to produce higher torque not only to take care of cold starts, but also to accelerate the engine quickly so that starting is transparent to the driver.

As mentioned, engine start/stop systems are sometimes employed in modern vehicles to reduce fuel consumption at vehicle idle. The BAS may be used in a vehicle to provide smooth and noise free engine restart compared to a crank shaft starter. The BAS employs an electric machine that is used in place of the engine belt driven generator, and is coupled to a high voltage battery through an inverter circuit. The electric machine is used as a motor for starting the engine and as a generator once the engine is running stably. The electric machine is also used as a motor to boost the torque of the engine to improve the vehicle performance. Smooth operation of the BAS under all operating conditions requires a fast response, low torque ripple electric machine. In the known vehicles employing a BAS, the three-phases of the AC synchronous or asynchronous alternator are connected to a three-phase active bridge circuit, which functions as a controlled rectifier when the BAS is in the generator mode and as an inverter when the BAS is in the motor mode. An asynchronous machine or a PM synchronous machine is typically employed to achieve long life due to their brushless operation. An asynchronous machine is preferred for its ruggedness and low cost due to the absence of PM material in the machine rotor.

The asynchronous electric machine in the BAS includes a stator and a rotor. The stator typically includes slots in which the electrical windings are wound. The rotor often includes electrically conductive bars (typically made of aluminum, copper or alloys thereof) positioned directly across an air gap from the windings in the stator slots that interact with the magnetic field generated by the windings to provide a higher rotor speed. However, the interaction of the bars in the rotor with the magnetic field of the windings creates a torque ripple that affects machine performance. Torque ripple is an oscillation in the machine torque as the rotor spins within the stator of the machine as a result of the change in the magnetic coupling between the rotor and stator. In order to reduce the torque ripple, it is known in the art to skew the rotor bars, i.e., position the bars at an angle relative to the stator slots. Although the skew in the rotor bars is effective for reducing or eliminating the torque ripple, it is difficult to provide the proper orientation of the skewed rotor bars during the machine manufacturing process, thus increasing the machine cost.

### SUMMARY OF THE INVENTION

In accordance with the teachings of the present invention, a BAS machine is disclosed that includes a specific combination of the number of stator slots to the number of rotor bars to reduce torque ripple without the need for skewing the rotor bars. Particularly, the ratio of the number of stator slots to the number of rotor bars is selected to prevent first and second order harmonics between the stator slots and the rotor bars, where the ratio includes 36/26, 54/44, 72/56, 72/58 or 72/62 for a six pole machine, 48/36, 72/52, 72/58 or 84/86 for an eight pole machine, and 60/44 or 60/46 for a ten pole machine.

Additional features of the present invention will become apparent from the following description and appended claims, taken in conjunction with the accompanying drawings.

### BRIEF DESCRIPTION OF THE DRAWINGS

FIG. 1 is a schematic block diagram of a vehicle engine system including a BAS machine;

FIG. 2 is a cross-sectional side view of the BAS machine shown in FIG. 1; and

FIG. 3 is a cross-sectional end view of the BAS machine showing stator slots and rotor bars.

### DETAILED DESCRIPTION OF THE EMBODIMENTS

The following discussion of the embodiments of the invention directed to a BAS multi-phase AC induction or asynchronous machine including a specific ratio of the number of stator slots to the number of rotor bars relative to the number of machine poles to reduce torque ripple is merely exemplary in nature, and is in no way intended to limit the invention or its applications or uses.

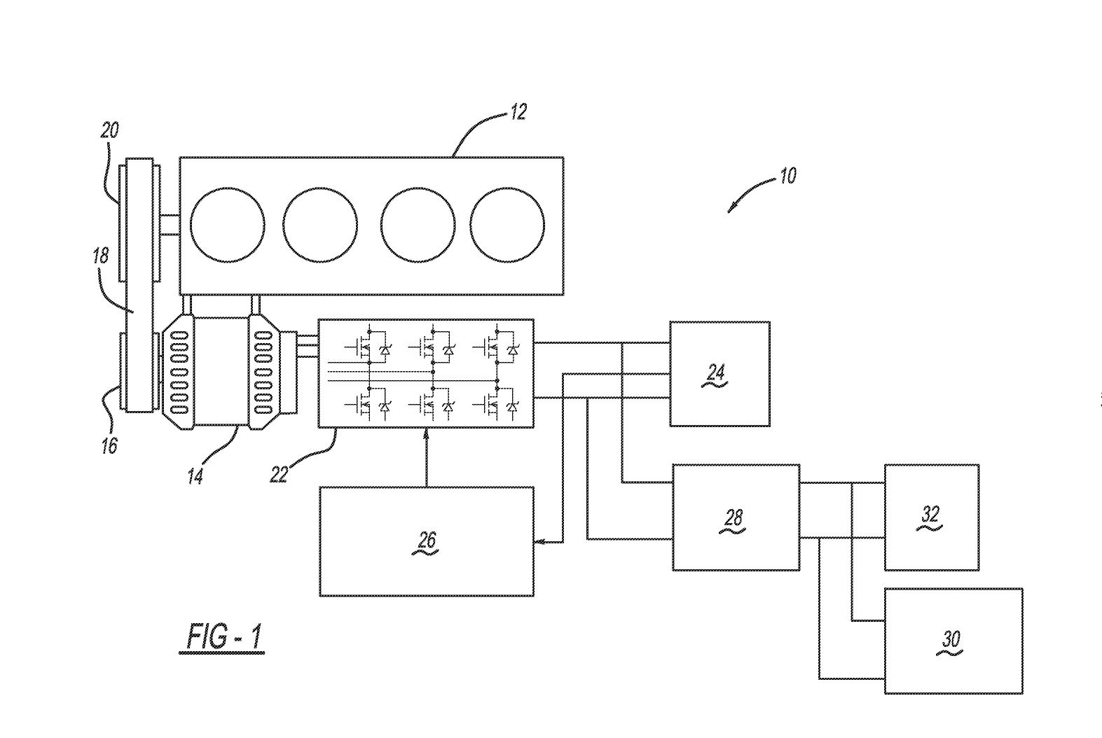

FIG. 1 is a general block diagram of a vehicle system 10 including an engine 12, such as an internal combustion engine. The vehicle system 10 also includes a BAS machine 14 having a pulley 16 that is coupled to a belt 18, which in turn is coupled to a pulley 20 mounted to the engine 12. When the BAS machine 14 rotates the pulley 16, the belt 18 rotates the engine 12 to start the engine 12 from a stopped condition in a manner that is well understood in the art. The BAS machine 14 can be a permanent magnet motor or an induction motor that receives an AC signal applied to stator windings in the machine 14. An inverter/rectifier circuit 22 includes two diodes and two switches for each winding in the machine 14, where the number of windings defines the number of phases of the machine 14. When the machine 14 is operating as a generator, the inverter/rectifier circuit 22 converts the AC signal from the machine 14 to a DC signal to charge a primary energy storage device 24, for example, a suitable battery or ultracapacitor, with voltage range of 10-200V. When the machine 14 is operating as an alternator, the inverter circuit/rectifier 22 converts the DC voltage from the primary energy storage device 24 to an AC signal selectively switched for each of the phases of the machine 14. A controller 26 controls the switches within the inverter/rectifier circuit 22 in a selective manner for both operating modes of the machine 14. The system 10 also includes a DC/DC converter 28 that converts the DC voltage from the primary energy storage device 24 to a voltage suitable for vehicle accessory and loads 30, such as a vehicle starter. An auxiliary energy storage device 32, such as a fourteen volt battery, is also provided in the vehicle system 10 to power the loads 30 when they are not being powered by the storage device 24, such as when the vehicle is off.

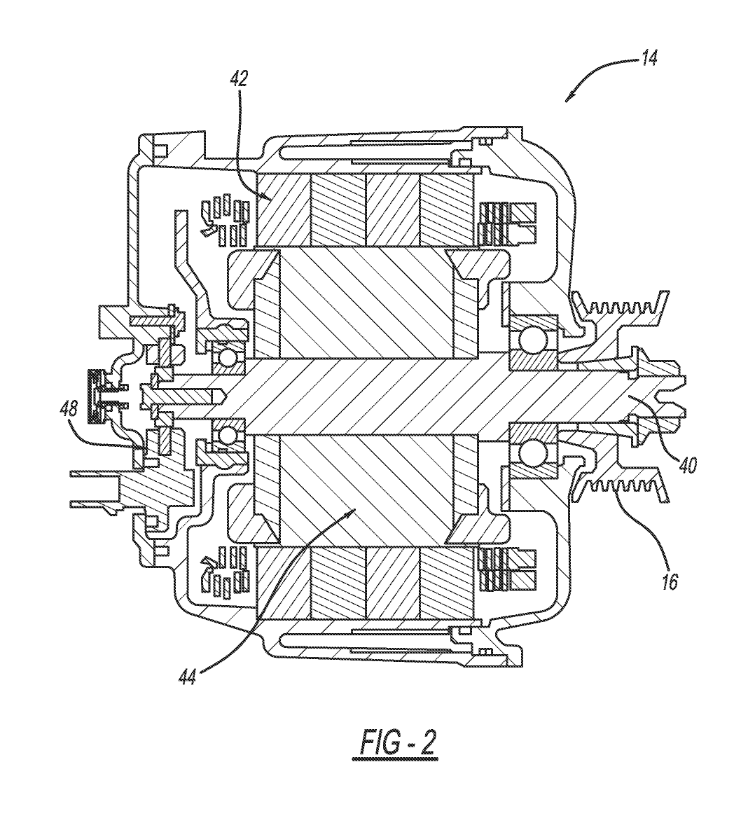

FIG. 2 is a cross-sectional view of the BAS machine 14 separated from the system 10 showing the pulley 16 rigidly coupled to a shaft 40. The BAS machine 14 includes a stator 42 and a rotor 44, where the rotor 44 is rigidly mounted to the shaft 40. The stator 42 includes windings that generate a magnetic field that interacts with the rotor 44 where the AC current applied to the stator windings causes the rotor 44 to turn in a manner that is well understood in the art, which in turn causes the shaft 40 to rotate. The BAS machine 14 further includes a rotor position and speed sensor 48.

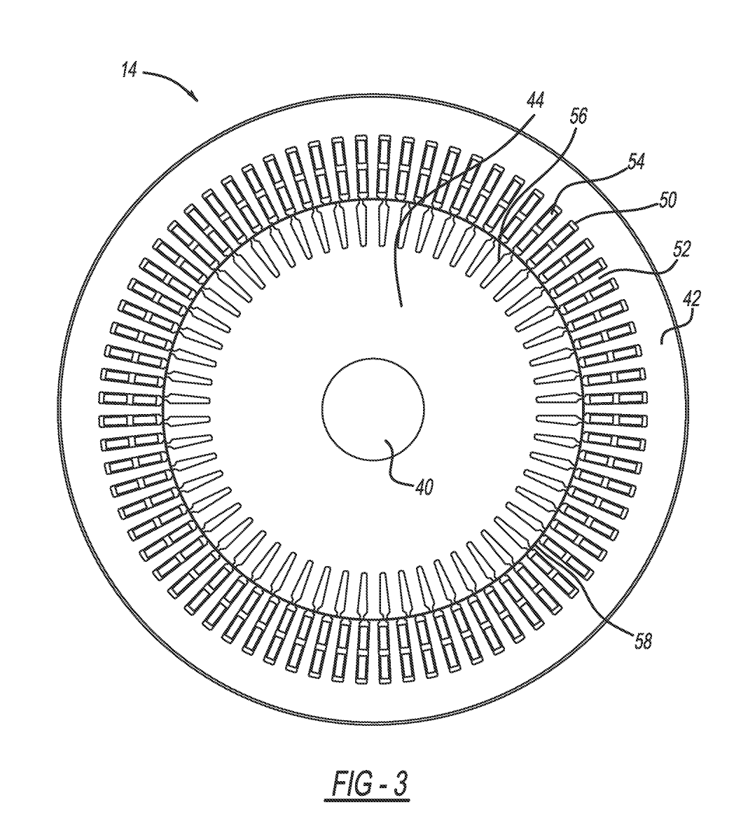

FIG. 3 is a cross-sectional end view of the BAS machine 14 showing the stator 42, the rotor 44 and the shaft 40. The stator 42 includes a plurality of stator slots 50 defined by stator teeth 52. A plurality of stator windings 54 are wound through the slots 50 and around the teeth 52, where the slots 50 are open to an air gap 58 between the stator 42 and the rotor 44. The rotor 44 includes a plurality of spaced apart bars 56 having ends that are adjacent to the air gap 58. As is apparent, the bars 56 are not skewed relative to the slots 50. In one embodiment, the air gap 58 has a width in the range of 0.2 mm-0.5 mm. Further, the BAS machine 14 can have a machine lamination outer diameter to active length ratio between 1 and 3.5. Also, in this non-limiting embodiment, there are 72 stator slots and 56 rotor bars.

It is known in the art that for a three-phase winding machine, the number of stator slots S₁ should be divisible by three. If the machine is wound for six or twelve poles P, the number of stator slots S₁ should be divisible by nine for a balanced winding. For integral slot windings, i.e., windings that have an equal number of coils in all groups, the number of slots per pole per phase should be a whole number. Integral slot windings permit more parallel circuits, hence a flexibility in the winding arrangement.

It is also known in the art that a large number of stator slots S₁ reduces the leakage reactance by reducing the slot leakage and the zig-zag leakage. This means more breakdown torque and a better efficiency and power factor. A large number of stator slots S₁ also reduces problems due to field harmonics, such as torque cusps and cogging. It also tends to reduce the intensity of magnetic noise, while at the same time increasing the frequency of the noise components. However, as the number of stator slots S₁ increases, the space factor of the slots S₁ becomes less so there is always a practical upper limit to the number of stator slots S₁. In general, this will also depend on the outer diameter of the stator lamination.

A large number of rotor slots (bars) S₂ is generally advantageous because it minimizes the rotor slot zig-zag reactance, thereby increasing the breakdown torque. A large number of rotor slots S₂ also tends to reduce cogging, torque cusps and noise. A large number of rotor slots S₂ also tends to reduce the tooth pulsations and results in surface losses. The straight load losses are affected by the difference between the number of rotor and stator slots, particularly, when there are more rotor slots S₂ than stator slots S₁. This effect is more pronounced with die-cast rotors and can become significant.

To minimize noise and vibration, S₁-S₂ should not equal +/−1, +/−2, +/−(P+/−1) or (P+/−2), where P is the number of machine poles. To avoid dead points or cogging, S₁-S₂ should not equal +/−mP or any multiple of +/−mP for poly-phase motors, where m is the number of machine phases. To avoid torque cusps, S₁-S₂ should not equal +/−P or, for three phase motors, −2P or −5P. Also, S₂ should not be equal to or be divisible by or be divisible into S₁.

It also has been proposed in the art to make the number of stator slots S₁ divisible by the number of poles. Experience has shown that this tends to reduce noise, but is accompanied by some cogging difficulties. For quiet motors, make S₂ different from S₁ by 20% or more. For lower motor reactance, make S₂ larger than S₁. For low stray load losses, make S₂ smaller than S₁ by a small amount, for example, on the order of 15%.

Cogging torques can be eliminated by making (S₁-5₂)/2p integral, (S₁/S₂) fractional and S₂ not widely different from S₁. Asynchronous harmonic torques are limited if S₂ does not exceed 1.25*S₁. To limit synchronous harmonic torques, S₂ should not be 6px or 6px+/−2p, where x is a positive integer and p=the pole pairs. To reduce slot harmonics, S₂ should not be made equal to S₁+/−to p or (1/2)S₁+/−p.

The present invention proposes an induction machine operable to be used as the BAS machine 14 that selectively defines the relative number of stator slots S₁ and the number of rotor bars S₂ depending on the number of poles P in the machine. As is known in the art, induction machines are designed to have a number of north and south poles P determined by the orientation of the windings, such as six poles, eight poles or ten poles to meet the torque and packaging requirements of the machine.

Torque ripple in an induction machine typically occurs because of the magnetic harmonics that are generated as the rotor rotates as a result of the magnetic coupling between the rotor and the stator. For example, it has been recognized that torque ripple occurs in an induction machine because first order harmonics exist between the orientation of the stator slots S₁ and the rotor bars S₂ for a synchronous torque at zero machine speed if the number of stator slots S₁ equals the number of rotor bars S₂, or for a synchronous torque at machine motoring if the number of rotor bars S₂ equals the number of stator slots S₁ plus the number of machine poles P, or for a synchronous motor torque at machine generating if the number of rotor bars S₂ equals the number of stator slots S₁ minus the number of poles P.

It has also been recognized that torque ripple occurs because harmonics exist due to the rotor bar and stator slot MMF for a synchronous machine torque at zero machine speed if the number of rotor bars S₂ equals the number of machine phases m times an integer k times the number of machine poles P, or at synchronous machine torque at machine motoring if the number of rotor bars S₂ equals the number of machine poles P times the number phases m times an integer k plus 1, or at synchronous motor torque at machine generating if the number of rotor bars S₂ equals the number of machine poles P times the number of phases m times the integer k minus 1.

It has further been recognized that torque ripple occurs as a result of second order harmonics between the stator slots S₁ and the rotor bars S₂ for synchronous motor torque at machine motoring if the number of rotor bars S₂ equals the number of stator slots S₁ plus the number of machine poles P divided by 2, or at synchronous torque at machine generating if the number of rotor bars S₂ equals the number of stator slots S₁ minus the number of poles P divided by 2. These observations are illustrated in Table I below.

TABLE I

| | | Harmonics due | |
|---|---|---|---|
| | 1st order slot/ | to rotor bar | 2nd order slot/ |
| | bar harmonics | and stator MMF | bar harmonics |
| synchronous torque | S₂ = S₁ | S₂ = mkP | |
| at zero speed | | | |
| synchronous torque | S₂ = S₁ + P | S₂ = P * (mk + 1) | S₂ = S₁ + P/2 |
| at motoring | | | |
| synchronous torque | S₂ = S₁ − P | S₂ = P * (mk − 1) | S₂ = S₁ − P/2 |
| at generating | | | |

k = 1, 2, 3
P = number of poles
m = number of phases

Based on these recognitions, the present invention proposes a number of specific combinations or ratios of the number of stator slots S₁ and the number of rotor bars S₂ so that these harmonics do not occur and torque ripple is thus reduced. For example, for a six pole machine, the number of stator slots S₁ can be 72, if the number of rotor bars S₂ is 56, 58 or 62. Further, for an eight pole machine, the number of stator slots S₁ can be 72 if the number of rotor bars S₂ is 52 or 58, the number of stator slots S₁ can be 84 if the number of rotor bars S₂ is 66, or the number of stator slots S₁ can be 48 if the number of rotor bars S₂ is 36. For a ten pole machine, the number of stator slots S₁ can be 60 if the number of rotor bars S₂ is 44 or 46. Further, the number of stator slots S₁ should be greater than three times the number of poles P (S₁>3*P), but less than twelve times the number of poles P (S₁<12*P). Further, S₁−S₂=+/−mP and S₁-S₂=+/−P+/−1 or 2.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. An electric machine comprising:
a stator including a number of stator slots separated by stator teeth, said stator further including a plurality of windings wound within the stator slots; and
a rotor rotatably mounted within the stator and defining an air gap therebetween, said rotor including a number of spaced apart rotor bars positioned adjacent to the air gap, wherein a ratio of the number of stator slots to the number of rotor bars is selected to prevent first and second order harmonics between the stator slots and the rotor bars.

2. The machine according to claim 1 wherein the machine is a six pole machine and the ratio of the number of stator slots to the number of rotor bars is 36/26, 54/44, 72/56, 72/58 or 72/62.

3. The machine according to claim 1 wherein the machine is an eight pole machine and the ratio of the number of stator slots to the number of rotor bars is 48/36, 72/52, 72/58 or 84/66.

4. The machine according to claim 1 wherein the machine is a ten pole machine and the ratio of the number of stator slots to the number of rotor bars is 60/44 or 60/46.

5. The machine according to claim 1 wherein the number of stator slots is greater than three times a number of poles of the machine but less than twelve times the number of poles of the machine.

6. The machine according to claim 1 wherein the machine is a belted-alternator-starter for a vehicle.

7. The machine according to claim 1 wherein the machine is an induction machine.

8. The machine according to claim 1 wherein the machine is a three-phase machine.

9. The machine according to claim 1 wherein the rotor bars are not skewed relative to the stator slots.

10. A three-phase, six pole induction machine comprising:
a stator including a number of stator slots separated by stator teeth, said stator further including a plurality of windings wound within the stator slots; and
a rotor rotatably mounted within the stator and defining an air gap therebetween, said rotor including a number of spaced apart rotor bars positioned adjacent to the air gap, wherein the ratio of the number of stator slots to the number of rotor bars is 36/26, 54/44, 72/56, 72/58 or 72/62.

11. The machine according to claim 10 wherein the machine is a belted-alternator-starter for a vehicle.

12. The machine according to claim 10 wherein the rotor bars are not skewed relative to the stator slots.

13. A three-phase, eight pole induction machine comprising:
a stator including a number of stator slots separated by stator teeth, said stator further including a plurality of windings wound within the stator slots; and
a rotor rotatably mounted within the stator and defining an air gap therebetween, said rotor including a number of spaced apart rotor bars positioned adjacent to the air gap, wherein the ratio of the number of stator slots to the number of rotor bars is 48/36, 72/52, 72/58 or 84/66.

14. The machine according to claim 13 wherein the machine is a belted-alternator-starter for a vehicle.

15. The machine according to claim 13 wherein the rotor bars are not skewed relative to the stator slots.

16. A three-phase, ten pole induction machine comprising:
a stator including a number of stator slots separated by stator teeth, said stator further including a plurality of windings wound within the stator slots; and
a rotor rotatably mounted within the stator and defining an air gap therebetween, said rotor including a number of spaced apart rotor bars positioned adjacent to the air gap, wherein the ratio of the number of stator slots to the number of rotor bars is 60/44 or 60/46.

17. The machine according to claim 16 wherein the machine is a belted-alternator-starter for a vehicle.

18. The machine according to claim 16 wherein the rotor bars are not skewed relative to the stator slots.
